(19) United States
(12) Patent Application Publication
(10) Pub. No.: US 2025/0298360 A1
(43) Pub. Date: Sep. 25, 2025

(54) POST-PROCESSING APPARATUS AND IMAGE FORMING APPARATUS

(71) Applicant: FUJIFILM Business Innovation Corp., Tokyo (JP)

(72) Inventors: Hina SAITO, Kanagawa (JP); Toru INOUE, Kanagawa (JP); Motoharu NAKAO, Kanagawa (JP)

(73) Assignee: FUJIFILM Business Innovation Corp., Tokyo (JP)

(21) Appl. No.: 18/773,775

(22) Filed: Jul. 16, 2024

(30) Foreign Application Priority Data
Mar. 21, 2024 (JP) 2024-045436

(51) Int. Cl. G03G 15/00; G03G 9/097

(52) U.S. Cl. CPC G03G 15/6585; G03G 9/09733; G03G 15/6529; G03G 15/6573

(57) ABSTRACT

A post-processing apparatus includes a support unit that fixes and supports a medium on which an image of a developer containing wax is fixed, and a rubbing unit that rubs a surface of the medium supported by the support unit while being in contact with the surface of the medium and moving along the surface of the medium.

### CROSS-REFERENCE TO RELATED APPLICATIONS

This application is based on and claims priority under 35 USC 119 from Japanese Patent Application No. 2024-045436 filed Mar. 21, 2024.

### BACKGROUND

### (i) Technical Field

The present disclosure relates to a post-processing apparatus and an image forming apparatus.

### (ii) Related Art

Regarding a technique of rubbing an image surface after fixing an image of a developer containing wax in an image forming apparatus, techniques described in the following Japanese Unexamined Patent Application Publication No. 2002-091205 ([0030] to [0041]), Japanese Unexamined Patent Application Publication No. 2023-087297 ([0054] to [0056]), and Japanese Unexamined Patent Application Publication No. 2005-266079 ([0028] to [0031]) are conventionally known.

Japanese Unexamined Patent Application Publication No. 2002-091205 ([0030] to) [0041] describes a technique of cleaning wax and toner components on media being transported after fixing by bringing a wind-up type web cleaning device, a cleaning roller having brush-like fibers formed into a cylindrical shape, or the like into contact with the media, and removing fogging, thereby preventing color muddiness.

Japanese Unexamined Patent Application Publication No. 2023-087297 ([0054] to) [0056] describes a technique of evaluating a fixing state by rubbing the image surface of paper transported after fixing with a rubbing member and comparing a reference image not rubbed with the image after the rubbing.

Japanese Unexamined Patent Application Publication No. 2005-266079 ([0028] to) [0031] describes a technique of removing wax by bringing a blade into contact with the surfaces of recording media being transported after fixing in a wax removing section on the downstream side of a fixing device.

### SUMMARY

Aspects of non-limiting embodiments of the present disclosure relate to suppressing the occurrence of wrinkles in a medium as compared with a case where the surface of the medium being transported is rubbed by a rubbing means.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a post-processing apparatus including a support unit that fixes and supports a medium on which an image of a developer containing wax is fixed, and a rubbing unit that rubs a surface of the medium supported by the support unit while being in contact with the surface of the medium and moving along the surface of the medium.

### BRIEF DESCRIPTION OF THE DRAWINGS

Exemplary embodiments of the present disclosure will be described in detail based on the following figures, wherein:

FIG. 1 is an explanatory view of an image forming apparatus of a first exemplary embodiment;

FIG. 2 is an explanatory view of the continuation of the image forming apparatus of FIG. 1;

FIG. 3 is an explanatory view of a rubbing unit of the first exemplary embodiment;

FIG. 4 is a diagram viewed from the direction of the arrow IV in FIG. 3;

FIG. 5 is an explanatory view of the action of the first exemplary embodiment, in which FIG. 5A is an explanatory view in a state where a recording paper is carried in, FIG. 5B is an explanatory view in a state where the recording paper is fixed, FIG. 5C is an explanatory view in the middle of rubbing processing, FIG. 5D is an explanatory view in a state where the rubbing processing is completed, and FIG. 5E is an explanatory view in a state where the recording paper is carried out;

FIG. 6 is an explanatory view of a rubbing unit of a second exemplary embodiment;

FIG. 7 is a perspective view of a rubbing device of a third exemplary embodiment; and

FIG. 8 is an explanatory view of the rubbing device of the third exemplary embodiment.

### DETAILED DESCRIPTION

Next, exemplary embodiments as specific examples of the present disclosure will be described with reference to the drawings, but the present disclosure is not limited to the following exemplary embodiments.

In order to facilitate understanding of the following description, in the drawings, the front-rear direction (a width direction of media) corresponds to X-axis direction, the right-left direction (a transport direction of media) to Y-axis direction, and the upper-lower direction to the Z-axis direction, and sides indicated by arrows X, −X, Y, −Y, Z, and −Z correspond to the front direction, rear direction, right direction, left direction, upper direction, and lower direction, respectively, or to the front side, rear side, right side, left side, upper side, and lower side, respectively.

Further, in the drawings, “·” in “∘” indicates an arrow directed from the back surface to the front surface of paper, and “×” in “∘” indicates an arrow directed from the front surface to the back surface of paper.

In the following description using the drawings, illustration of members other than those necessary for the description is omitted as appropriate so as to facilitate understanding.

### First Exemplary Embodiment

### (Description of Overall Configuration of Printer U of First Exemplary Embodiment)

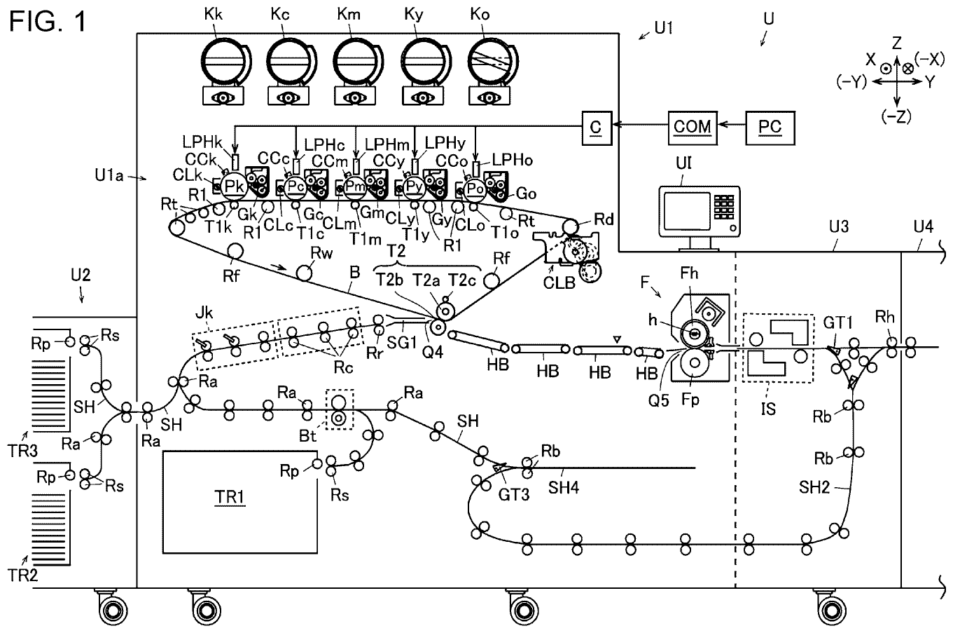

FIG. 1 is an explanatory view of an image forming apparatus of a first exemplary embodiment.

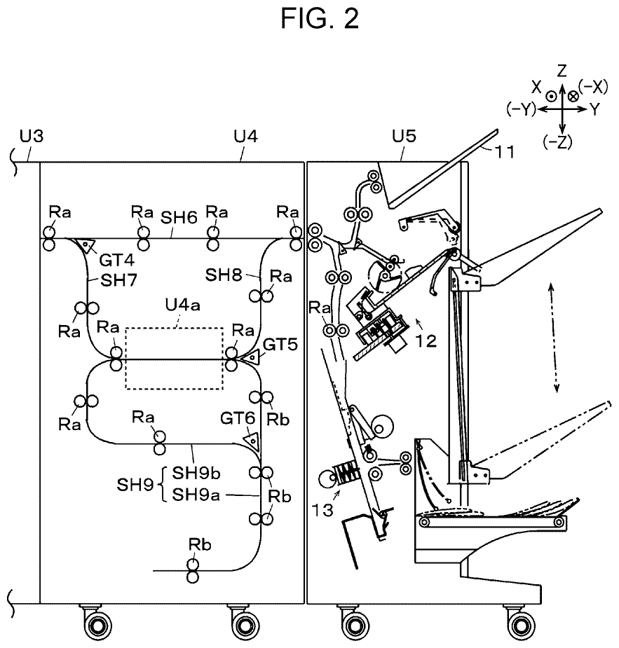

FIG. 2 is an explanatory view of the continuation of the image forming apparatus of FIG. 1.

In FIGS. 1 and 2, a printer U as an example of an image forming apparatus according to the first exemplary embodiment of the present disclosure includes a printer main body U1, a feeder unit U2 as an example of a media feeding device, an operation unit UI, an inspection device U3, a rubbing device U4 as an example of a first post-processing apparatus, and a finisher U5 as an example of a second post-processing apparatus.

The feeder unit U2 supplies media to the printer main body U1. The operation unit UI is used by a user to perform an input operation and to confirm settings and a state of the printer U. The inspection device U3 inspects a formed image. The rubbing device U4 rubs the surface of a formed image. The finisher U5 performs post-processing, such as alignment, end binding, and saddle stitching, on a printed recording paper S.

### (Description of Configuration of Marking of First Exemplary Embodiment)

In FIG. 1, the printer main body U1 includes a controller (an example of a control means) C that controls the printer U. The printer main body U1 is connected to a print image server COM as an example of an information transmission device via a dedicated cable (not illustrated). A personal computer PC as an example of an image transmission device is connected to the print image server COM through a cable or a line such as a local area network (LAN). The personal computer PC transmits the information of an image to be printed by the printer U to the print image server COM, and the print image server COM transmits the image information to the printer main body U1.

A marking section U1a, which is an example of a recording means that records images on media, is provided inside the printer main body U1. The marking section U1a include, as an example of an image holding means, photoreceptors Py, Pm, Pc, and Pk for the colors of yellow (Y), magenta (M), cyan (C), and black (K), respectively, and a photoreceptor Po for a special color used to form a special image such as a transparent toner image or a corporate color image.

In FIG. 1, a charger CCk as an example of a charging means, an exposure device LPHk as an example of a latent-image forming means, a developing device Gk as an example of a developing means, a first transfer roller T1k as an example of a first transfer means, and a photoreceptor cleaner CLk as an example of a cleaning means for an image holding means are disposed around the black photoreceptor Pk along the rotation direction of the photoreceptor Pk.

Similarly, chargers CCy, CCm, CCc, and CCo, exposure devices LPHy, LPHm, LPHc, and LPHo, developing devices Gy, Gm, Gc, and Go, first transfer rollers T1y, T1m, T1c, and T1o, and photoreceptor cleaners CLy, CLm, CLc, and CLo are disposed around the other photoreceptors Py, Pm, Pc, and Po.

Above the marking section U1a, toner cartridges Ky, Km, Kc, Kk, and Ko as an example of a developer storage means are removably supported. The toner cartridges Ky to Ko store a developer to be supplied to the developing devices Gy to Go, respectively. In the first exemplary embodiment, the developer contains wax for the purpose of improving the peeling performance of the recording paper from the fixing member at the time of fixing.

The chargers CCy to CCo, the exposure devices LPHy to LPHo, the developing devices Gy to Go, and the like form image forming means CCy to CCo, LPHy to LPHo, and Gy to Go of the first exemplary embodiment that form developer images on the photoreceptors Py to Po.

Below the photoreceptors Py to Po, an intermediate transfer belt B is arranged as an example of an intermediate transfer means and as an example of an image holding means. The intermediate transfer belt B is interposed between the photoreceptors Py to Po and the first transfer rollers T1y to T1o. The back surface of the intermediate transfer belt B is supported by a drive roller Rd as an example of a drive means, a tension roller Rt as an example of a tensile force-applying means, a walking roller Rw as an example of a meandering prevention means, a plurality of idler rollers Rf as an example of a driven means, a backup roller T2a as an example of an opposing means for second transfer, a plurality of retracting rollers R1 as an example of a movable means, and the first transfer rollers T1y to T1o.

On the surface of the intermediate transfer belt B, a belt cleaner CLB as an example of a cleaning means for the intermediate transfer means is disposed in the vicinity of the drive roller Rd.

A second transfer roller T2b as an example of a second transfer member is disposed so as to face the backup roller T2a with the intermediate transfer belt B interposed therebetween. Further, a contact roller T2c as an example of a contact means is in contact with the backup roller T2a. The contact roller T2c applies a voltage having a polarity opposite to the charging polarity of the developer on the backup roller T2a.

The backup roller T2a, the second transfer roller T2b, and the contact roller T2c form a second transfer unit T2 as an example of a second transfer means of the first exemplary embodiment. The first transfer rollers T1y to T1o, the intermediate transfer belt B, the second transfer unit T2, and the like form the transfer devices T1, B, and T2 as an example of a transfer means of the first exemplary embodiment.

Below the second transfer unit T2, a paper feed tray TR1 is provided as an example of a storage means. The paper feed tray TR1 stores recording paper S as an example of a medium. A pickup roller Rp as an example of a take-out means and a separation roller Rs as an example of a separation means are disposed on the diagonally upper side of the paper feed tray TR1. A transport path SH along which the recording paper S is transported extends from the separation roller Rs. A plurality of transport rollers Ra as an example of a transport means that transports the recording paper S to the downstream side are disposed along the transport path SH.

A deburring device Bt as an example of an unnecessary portion removing means is disposed on the downstream side of the separation roller Rs. The deburring device Bt transports the recording paper S to the downstream side while nipping the recording paper S with a preset pressure, and removes an unnecessary portion of the end of the recording paper S, a so-called burr.

On the downstream side of the deburring device Bt, a double feed detection device Jk is disposed. The double feed detection device Jk measures the thickness of passing recording paper S and detects a state in which a plurality of pieces of recording paper S overlap each other, so-called double feed.

On the downstream side of the double feed detection device Jk, correction rollers Rc as an example of a posture correct means are disposed. The correction roller Rc corrects inclination of the recording paper S with respect to the transport direction, that is, skew.

On the downstream side of the correction rollers Rc, a registration roller Rr is disposed as an example of an adjustment means for adjusting the timing of transporting the recording paper S to the second transfer unit T2. On the downstream side of the registration roller Rr, a sheet guide SG1 is disposed as an example of a media guide means.

The feeder unit U2 is also provided with paper feed trays TR2 and TR3, and the like that are configured in the same manner as the paper feed tray TR1, the pickup roller Rp, the separation roller Rs, and the transport roller Ra. The transport path SH from the paper feed trays TR2 and TR3 merges with the transport path SH of the printer main body U1 on the upstream side of the double feed detection device Jk.

A plurality of transport belts HB as an example of a medium transport means are disposed on the downstream side of the second transfer roller T2b in the transport direction of the recording paper S.

A fixing device F as an example of a fixing means is disposed on the downstream side of the transport belt HB in the transport direction of the recording paper S.

The image forming means CCy to CCo, LPHy to LPHo, and Gy to Go, the transfer devices T1, B, and T2, the fixing device F, and the like form the marking section U1a of the first exemplary embodiment.

An inspection device IS as an example of an image reading means is arranged in the inspection device U3 on the downstream side of the fixing device F.

A transport path SH is formed on the downstream side of the inspection device IS. The transport path SH extends toward the rubbing device U4. An inversion path SH2 as an example of a transport path branching from the transport path SH is formed on the downstream side of the inspection device IS. A first gate GT1 as an example of a transport direction switching means is disposed at a branching portion between the transport path SH and the inversion path SH2. A plurality of transport rollers Ra as an example of a transport means are disposed along the inversion path SH2.

On the downstream side of the inversion path SH2, a return path SH4 for reversing the transport direction of the recording paper S, that is, for switching back the recording paper S, is disposed below the fixing device F. A switchback roller Rb as an example of a transport means capable of rotating forward and backward is disposed on the return path SH4. A third gate GT3 as an example of a transport direction switching means is disposed at the entrance of the return path SH4.

The transport path SH on the downstream side of the return path SH4 merges with the transport path SH of the paper feed tray TR1.

In FIG. 2, a bypass path SH6 as an example of a transport path is formed in the rubbing device U4 on the downstream side of the inspection device IS. The transport rollers Ra as an example of a transport means are disposed in the bypass path SH6.

A rubbing carry-in path SH7 as an example of a transport path is branched from the upstream part of the bypass path SH6. The rubbing carry-in path SH7 extends downward from the bypass path SH6. A gate GT4 as an example of a switching means is disposed at a branching portion between the bypass path SH6 and the rubbing carry-in path SH7. The rubbing carry-in path SH7 is connected to a rubbing unit U4a as an example of a rubbing means. The transport rollers Ra as an example of a transport means are disposed in the rubbing carry-in path SH7.

A rubbing carry-out path SH8 as an example of a transport path is connected to the exit of the rubbing unit U4a. The rubbing carry-out path SH8 extends upward and merges with the downstream part of the bypass path SH6.

The transport rollers Ra as an example of a carry-out means are disposed in the rubbing carry-out path SH8.

A rubbing inversion path SH9 as an example of a transport path is branched from the upstream part of the rubbing carry-out path SH8. The rubbing inversion path SH9 includes a rubbing inversion lead-out path SH9a extending downward and a rubbing inversion lead-in path SH9b branched from the rubbing inversion lead-out path SH9a and connected to the entrance of the rubbing unit U4a. A gate GT5 as an example of a switching means is disposed at a branching portion between the rubbing carry-out path SH8 and the rubbing inversion lead-out path SH9a. A gate GT6 as an example of a switching means is disposed at a branching portion between the rubbing inversion lead-out path SH9a and the rubbing inversion lead-in path SH9b.

As an example of a transport means, the switchback rollers Rb capable of rotating forward and backward are disposed in the rubbing inversion lead-out path SH9a. As an example of a transport means, the transport rollers Ra capable of rotating forward and backward are disposed in the rubbing inversion lead-in path SH9b.

The downstream end of the bypass path SH6 extends toward the finisher U5.

The finisher U5 includes a top tray 11 as an example of a stacking means, an end binding device 12 as an example of a first post-processing means, and a saddle stitching device 13 as an example of a second post-processing means. The recording paper S is discharged and stacked on the top tray 11 without being subjected to post-processing. The end binding device 12 is capable of binding the end portions of the recording paper S with a stapler or discharging a plurality of recording paper S in a state where the sides of a plurality of pieces of recording paper S are aligned (aligned state) without binding them. The saddle stitching device 13 is capable of stitching the central portions of the recording paper S with a stapler and discharging the recording paper S folded in two. Note that the finisher U5 is not limited to have the exemplified configuration. For example, as an example of the post-processing, it is possible to use a finisher having a function of forming punch holes or a function of three folding (so-called Z-folding or C-folding).

### (Marking Operation)

When the printer U receives image information transmitted from a personal computer PC via the print image server COM, a job that is an image forming operation is started. When the job is started, the photoreceptors Py to Po, the intermediate transfer belt B, and the like are rotated.

The photoreceptors Py to Po are rotationally driven by a drive source (not illustrated).

A preset voltage is applied to the chargers CCy to CCo to charge the surfaces of the photoreceptors Py to Po.

The exposure devices LPHy to LPHo as an example of a latent image forming device and an example of a light emitting device output light for writing a latent image in response to a control signal from the controller C so as to write electrostatic latent images on the charged surfaces of the photoreceptors Py to Po.

The developing devices Gy to Go develop the electrostatic latent images on the surfaces of the photoreceptors Py to Po.

The toner cartridges Ky to Ko replenish a developer consumed by the development in the developing devices Gy to Go.

A first transfer voltage having a polarity opposite to the polarity to which the developer is charged is applied to the first transfer rollers T1y to T1o so that visible images on the surfaces of the photoreceptors Py to Po are transferred to the intermediate transfer belt B.

The photoreceptor cleaners CLy to CLo remove the developer remaining on the surfaces of the photoreceptors Py to Po after the first transfer to clean the photoreceptors Py to Po.

While the intermediate transfer belt B passes through the first transfer region facing the photoreceptors Py to Po, the images are transferred and stacked in the order of O, Y, M, C, and K, and then the intermediate transfer belt B passes through the second transfer region Q4 facing the second transfer unit T2. In the case of a monochrome image, an image of only one color is transferred and sent to the second transfer region Q4.

The pickup roller Rp feeds the recording paper S from the paper feed trays TR1 to TR3 to which the recording paper S is supplied, in accordance with the received size of image information and the received designation of the recording paper S, the size and type of stored recording paper S, and the like.

The separation roller Rs separates and handles the recording paper S fed from the pickup roller Rp one by one.

The deburring device Bt removes burrs by applying a preset pressure onto passing recording paper S.

The double feed detection device Jk measures a thickness of passing recording paper S and detects double feed of the recording paper S.

The correction rollers Rc correct skew by bringing passing recording paper S into contact with a wall surface (not illustrated).

The registration roller Rr feeds recording paper S in accordance with the timing at which the image on the surface of the intermediate transfer belt B is sent to the second transfer region Q4.

The sheet guide SG1 guides the recording paper S fed by the registration roller Rr to the second transfer region Q4.

The second transfer unit T2 transfers the image on the intermediate transfer belt B to recording paper S by applying a second transfer voltage having the same polarity as the preset charging polarity of the developer onto the backup roller T2a via the contact roller T2c.

The belt cleaner CLB removes the developer remaining on the surface of the intermediate transfer belt B after the image is transferred in the second transfer region Q4 to clean the intermediate transfer belt B.

The transport belt HB holds thereon the recording paper S to which the image has been transferred by the second transfer unit T2, and transports the recording paper S to the downstream side.

The fixing device F includes a heating roller Fh as an example of a heating member and a pressure roller Fp as an example of a pressure member. A heater h as an example of a heat source is accommodated in the heating roller Fh. The fixing device F heats the recording paper S passing through a fixing region Q5 where the heating roller Fh and the pressure roller Fp are in contact with each other while pressing the recording paper S, so as to fix an unfixed image on the surface of the recording paper S. The heating roller Fh and the pressure roller Fp form the fixing members Fp and Fh of the first exemplary embodiment.

The inspection device IS reads an image on the recording paper S having passed through the fixing device F, and inspects image defects.

In a case where double-sided printing is performed, the recording paper S having passed through the inspection device IS is transported to the inversion path SH2 by the operation of the first gate GT1, switched back in the return path SH4, and transported again to the registration roller Rr through the transport path SH, so that printing is performed on the second side.

The recording paper S having passed through the inspection device IS is carried into the rubbing device U4. In a case where rubbing processing for rubbing the surface of the recording paper S is not performed in the rubbing device U4, the recording paper S is transported through the bypass path SH6 by the switching of the gate GT4.

In a case where the rubbing processing is performed, the recording paper S is sent to the rubbing unit U4a through the rubbing carry-in path SH7 by the switching of the gate GT4. The rubbing unit U4a performs rubbing processing of rubbing the surface (one surface) of the recording paper S. The recording paper S after the rubbing processing is sent out to the rubbing carry-out path SH8.

In a case where the rubbing processing on both surfaces is not performed, the recording paper S in the rubbing carry-out path SH8 is sent to the bypass path SH6 by the switching of the gate GT5. In a case where the rubbing processing on both surfaces is performed, the recording paper S is sent to the rubbing inversion path SH9 by the switching of the gate GT5. The recording paper S having passed through the rubbing inversion path SH9 is carried into the rubbing unit U4a in a state where the front and back sides are reversed, and is subjected to rubbing processing of rubbing the back side of the recording paper S.

The recording paper S transported through the bypass path SH6 is carried into the finisher U5.

The recording paper S carried into the finisher U5 is sent to any one of the top tray 11, the end binding device 12, and the saddle stitching device 13 in accordance with the set type of post-processing. The recording paper S sent to the end binding device 12 is subjected to end-binding processing, and discharged. The recording paper S sent to the saddle stitching device 13 is subjected to saddle switching processing, and discharged.

### (Description of Rubbing Unit)

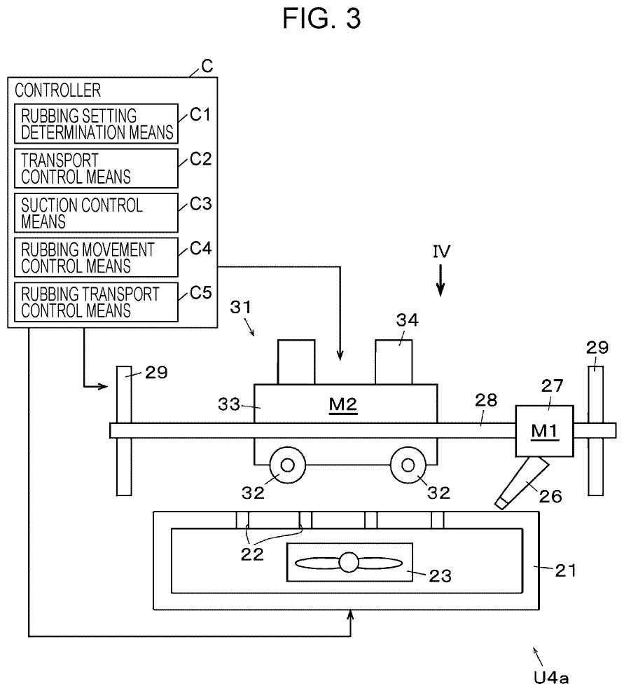

FIG. 3 is an explanatory view of the rubbing unit of the first exemplary embodiment.

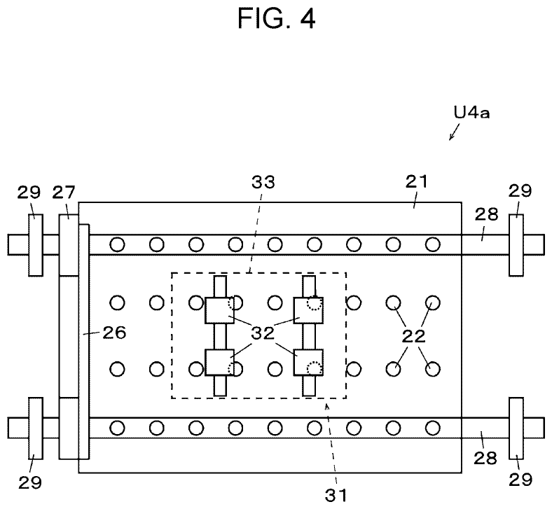

FIG. 4 is a diagram viewed from the direction of the arrow IV in FIG. 3.

In FIGS. 3 and 4, the rubbing unit U4a of the first exemplary embodiment includes a support base 21 as an example of a support means. The recording paper S transported by the transport rollers Ra (an example of a carry-in means) of the rubbing carry-in path SH7 or the rubbing inversion path SH9 is carried in onto the upper surface of the support base 21 of the first exemplary embodiment. A plurality of suction holes 22 as an example of a suction means are formed on the upper surface of the support base 21.

A fan 23 as an example of a suction means is disposed inside the support base 21. The fan 23 sucks air from the suction holes 22 when operated, thereby sucking the recording paper S onto the upper surface of the support base 21 by air suction force to fix and support the recording paper S.

A rubbing blade 26 as an example of a rubbing means is disposed above the support base 21. The rubbing blade 26 is formed of a plate-shaped member (a plate-shaped means) having a length covering the entire area in the width direction of the recording paper S. The rubbing blade 26 is supported by rubbing sliders 27 as an example of a rubbing moving means. The rubbing sliders 27 are disposed at both end portions in the width direction of the recording paper S. The rubbing sliders 27 are supported by a rubbing guide rail 28 as an example of a rubbing guide means. The rubbing guide rail 28 extends along the transport direction of the recording paper S. A rubbing movement motor M1 is provided in the rubbing slider 27. With forward and reverse rotation of the rubbing movement motor M1, the rubbing slider 27 is able to reciprocate in the transport direction of the recording paper S along the rubbing guide rail 28.

Both front and rear end portions of the rubbing guide rail 28 are supported by rubbing lift mechanisms 29 as an example of a rubbing lift means. The rubbing lift mechanism 29 moves the rubbing guide rail 28 in the vertical direction, that is, in a direction approaching or separating from the support base 21. Therefore, the rubbing guide rail 28, the rubbing slider 27, and the rubbing blade 26 can be raised and lowered by the operation of the rubbing lift mechanism 29.

Above the support base 21, a rubbing transport unit 31 as an example of a carry-in means and an example of a carry-out means is arranged at a position on the inner side of the rubbing guide rails 28. The rubbing transport unit 31 includes rubbing transport rollers 32 as an example of a transport means. The rubbing transport rollers 32 are supported by a lift frame 33 as an example of a frame body. The lift frame 33 is liftably supported by a transport lift device 34 with respect to the rubbing device U4. A rubbing transport motor M2 driving the rubbing transport rollers 32 is provided in the lift frame 33.

The rubbing unit U4a is controlled by a controller C as an example of a control means. The controller C includes an input/output interface I/O that inputs and outputs signals to and from the outside. The controller C includes a read-only memory (ROM) in which programs, information, and the like for necessary processing are stored. The controller C also includes a random access memory (RAM) that temporarily stores necessary data. In addition, the controller C includes a central processing unit (CPU) that performs processing in accordance with programs stored in the ROM or the like. Thus, the controller C of the first exemplary embodiment is formed by a small information processing device, a so-called microcomputer. Therefore, the controller C is able to realize various functions by executing programs stored in the ROM or the like.

The controller C of the first exemplary embodiment outputs signals to the fan 23, the rubbing movement motor M1, the rubbing lift mechanism 29, the rubbing transport motor M2, the transport lift device 34, the gates GT4 to GT6, and the transport rollers Ra and Rb, which are controlled elements, in accordance with the setting for rubbing processing (presence or absence of rubbing processing, single-sided or double-sided), and controls the controlled elements.

### (Function of Controller C)

The controller C of the first exemplary embodiment includes the following functional means (function modules and program modules) C1 to C5.

A rubbing setting determination means C1 determines the setting content of rubbing processing. The rubbing setting determination means C1 of the first exemplary embodiment determines the presence or absence of rubbing processing and whether the rubbing processing is single-sided rubbing processing or double-sided rubbing processing on the basis of the setting information of the rubbing processing included in the image information transmitted from the personal computer PC.

A transport control means C2 controls switching of the gates GT4 to GT6 and driving and stopping of the transport rollers Ra and Rb on the basis of the presence or absence of rubbing processing and the setting of one surface/both surfaces.

A suction control means C3 controls the start and stop of the fan 23. The suction control means C3 of the first exemplary embodiment operates the fan 23 when the recording paper S is carried in onto the support base 21. After the rubbing blade 26 rubs the surface of the recording paper S, the fan 23 is stopped.

The rubbing movement control means C4 controls the rubbing movement motor M1 and the rubbing lift mechanism 29 to control the movement of the rubbing blade 26. The rubbing movement control means C4 of the first exemplary embodiment controls the rubbing lift mechanism 29 to lower the rubbing blade 26 when the recording paper S is carried in onto the support base 21. When the recording paper S is sucked to the support base 21, the rubbing movement motor M1 is controlled so that the rubbing blade 26 reciprocates along the transport direction. In the first exemplary embodiment, one reciprocation is set, but two or more times of reciprocation may be also set. Once the reciprocating movement of the rubbing blade 26 is completed, the rubbing lift mechanism 29 is controlled to raise the rubbing blade 26.

A rubbing transport control means C5 controls the rubbing transport motor M2 and the transport lift device 34 to control the driving and lifting of the rubbing transport roller 32. Before the recording paper S is carried in onto the support base 21, the rubbing transport control means C5 of the first exemplary embodiment controls the transport lift device 34 to lower the rubbing transport roller 32, and controls the rubbing transport motor M2 to drive the rubbing transport roller 32. Once the recording paper S is carried in onto the support base 21, the rubbing transport roller 32 is moved upward and stopped. Once the reciprocating movement of the rubbing blade 26 is completed, the rubbing transport roller 32 is lowered and driven.

### (Action of First Exemplary Embodiment)

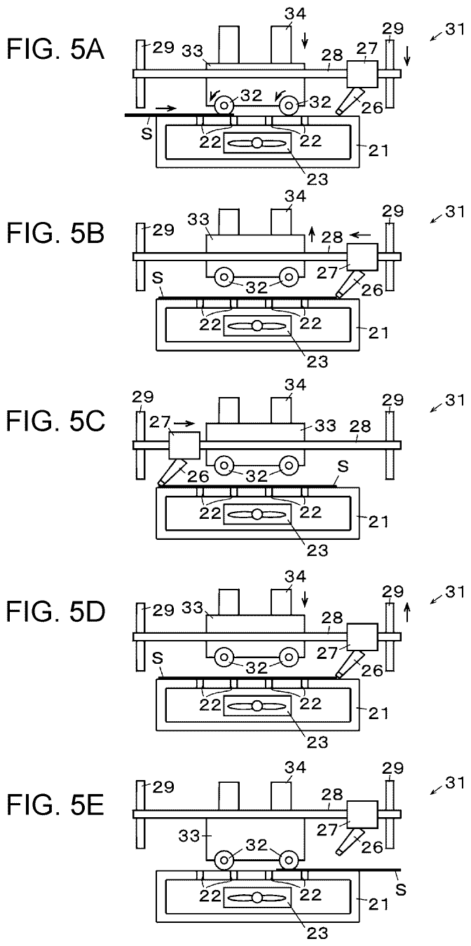

FIG. 5 is an explanatory view of the action of the first exemplary embodiment, in which FIG. 5A is an explanatory view in a state where recording paper is carried in, FIG. 5B is an explanatory view in a state where the recording paper is fixed, FIG. 5C is an explanatory view in the middle of rubbing processing, FIG. 5D is an explanatory view in a state where the rubbing processing is completed, and FIG. 5E is an explanatory view in a state where the recording paper is carried out.

In the rubbing device U4 of the first exemplary embodiment having the above-described configuration, the recording paper S on which an image is recorded is sent to the rubbing unit U4a in a case where the rubbing processing is performed. Before the recording paper S is carried in onto the support base 21, the rubbing transport rollers 32 are driven in a lowered state, and the rubbing blade 26 is lowered and moved to a position on the front end side in the paper transport direction, as illustrated in FIG. 5A. As illustrated in FIGS. 5A and 5B, the recording paper S is transported on the upper surface of the support base 21 by the rubbing transport rollers 32 until the front end of the recording paper S reaches the position of the rubbing blade 26. Once the transport of the recording paper S by the rubbing transport rollers 32 is completed, the rubbing transport rollers 32 are separated upward. Then, the fan 23 is operated, and the recording paper S is fixed on the support base 21.

In FIGS. 5B and 5C, when the recording paper S is fixed on the support base 21, the rubbing blade 26 is moved. Then, the upper surface of the recording paper S is rubbed.

In FIGS. 5C and 5D, once the reciprocating movement of the rubbing blade 26 is completed, the rubbing blade 26 is moved upward. Moreover, the rubbing transport rollers 32 are moved downward.

In FIGS. 5D and 5E, once the rubbing transport rollers 32 are lowered, the fan 23 is stopped to release the fixation of the recording paper S, and the recording paper S is carried out by the rubbing transport rollers 32.

When both surfaces of the recording paper S is rubbed, the reversed recording paper S is carried in, and the steps from FIGS. 5A to 5E are repeated with respect to the back surface.

Therefore, in the rubbing unit U4a of the first exemplary embodiment, the recording paper S is rubbed by the rubbing blade 26 in a state where the recording paper S is fixed and stopped on the support base 21. On the upper surface of the recording paper S, the wax of the developer that has been heated and melted at the time of fixing may be aggregated and solidified in a spherical shape when the wax is cooled and solidified. The spherical wax scatters light and causes image defects such as gloss unevenness. In the first exemplary embodiment, the spherical wax is rubbed by the rubbing blade 26. Therefore, the wax is smoothed (leveled) so as to be crushed by the rubbing blade 26. This suppresses gloss unevenness, and suppresses image defects. As in the related art, in a configuration in which the recording paper S being transported is rubbed, a damage to the paper such as paper wrinkles is likely to occur during transport if the paper has a small basis weight or has low rigidity. Further, in a case where a roller-shaped rubbing member is used as in Japanese Unexamined Patent Application Publication No. 2002-091205 (“0030” to “0041”), paper may be wound around the rubbing member, thus causing paper jam or a damage to the paper. Meanwhile, in the first exemplary embodiment, the recording paper S is rubbed in a state fixed on the support base 21, which suppresses the occurrence of wrinkles in the recording paper S as compared with a case where the surface of the recording paper S being transported is rubbed by the rubbing means.

Moreover, some of the wax may be attached onto the heating roller Fh during melting in the fixing device F, and may be attached onto the pressure roller Fp from the heating roller Fh after the recording paper S passes through. The wax attached on the pressure roller Fp may be attached to the back surface of the subsequent recording paper S, and the wax attached on the back surface of the recording paper S may solidify into a spherical shape. In a case where a transparent medium such as an OHP film is used as the recording paper S, the wax attached on the back surface of the transparent medium may scatter light transmitted through the transparent medium, resulting in gloss unevenness. In the first exemplary embodiment, it is possible to rub both surfaces of the recording paper S, and suppress gloss unevenness on both surfaces at the time of single-sided printing or double-sided printing on a transparent medium.

In the first exemplary embodiment, the recording paper S is fixed by air suction force in the fan 23. Thus, the recording paper S is not pressed by a physical member. Therefore, a pressing member does not hinder the rubbing work by the rubbing blade 26, which enables the rubbing work to be smoothly performed.

Further, in the first exemplary embodiment, the recording paper S is carried in onto and out from the support base 21 by the rubbing transport rollers 32. Therefore, it is not necessary to manually set the recording paper S after image formation in the rubbing device U4, which automates the processing of rubbing the recording paper S by the rubbing unit U4a.

Furthermore, in the first exemplary embodiment, the recording paper S is rubbed by the plate-like rubbing blade 26. Therefore, with a rotating roll-shaped rubbing blade or the like, the force for smoothing the wax may be insufficient unless the rubbing blade is pressed against the recording paper S with a certain degree of force, while with the rubbing blade 26, it is possible to suppress the pressing force.

Further, in the first exemplary embodiment, in a case where both surfaces of the recording paper S is rubbed, the recording paper S is reversed in the rubbing inversion path SH9. If another rubbing unit is installed at a position symmetrical between the front and back on the downstream side in the paper transport direction of the rubbing unit U4a, it is also possible to rub both surfaces of the recording paper S without reversing the recording paper S. However, two rubbing units are required in this case, whereby the number of components is increased, and the cost tends to be increased. In particular, when rubbing processing is performed on only one surface, one unit is not used at all, which is wasteful. Meanwhile, in the first exemplary embodiment, the rubbing inversion path SH9 is provided, enabling one rubbing unit U4a to rub both surfaces of the recording paper S.

### Second Exemplary Embodiment

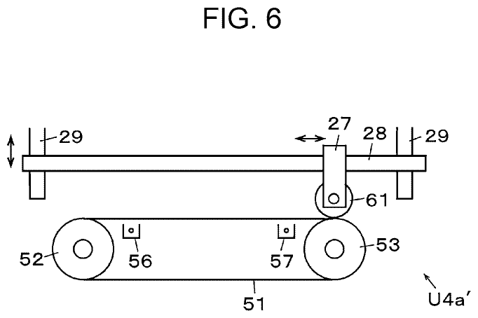

FIG. 6 is an explanatory view of a rubbing unit of a second exemplary embodiment.

Next, the second exemplary embodiment of the present disclosure will be described. In the description of the second exemplary embodiment, components corresponding to those of the first exemplary embodiment are denoted by the same reference numerals, and detailed description thereof will be omitted.

The second exemplary embodiment is different from the first exemplary embodiment in the following points, but is similar to the first exemplary embodiment in the other points.

In FIG. 6, a rubbing unit U4a′ of the second exemplary embodiment includes a support belt 51 as an example of the support member, instead of the support base 21. The support belt 51 is stretched by a drive roller 52 as an example of a drive means and a follower roller 53 as an example of a driven means. The support belt 51 is rotatable in accordance with driving of the drive roller 52. Thus, when the support belt 51 of the second exemplary embodiment rotates in a state where the recording paper S is placed on the surface of the support belt 51, the recording paper S can be transported to the downstream side. Therefore, the support belt 51 of the second exemplary embodiment also has the function of the rubbing transport roller 32 of the first exemplary embodiment, that is, the function as a carry-out means.

A charging corotron 56 as an example of a charging means is disposed on the inner side of the support belt 51. The charging corotron 56 is disposed at a position on the upper surface of the support belt 51 on the upstream side in the paper transport direction. The charging corotron 56 charges the support belt 51.

Further, a discharging corotron 57 as an example of a discharging means is disposed on the inner side of the support belt 51. The discharging corotron 57 is disposed at a position on the upper surface of the support belt 51 on the downstream side in the paper transport direction. The discharging corotron 57 discharges the support belt 51.

The rubbing unit U4a′ of the second exemplary embodiment includes a rubbing roller 61 as an example of a rotating means instead of the rubbing blade 26 of the first exemplary embodiment. The rubbing roller 61 is rotatably supported by the rubbing slider 27. Therefore, with the reciprocating movement of the rubbing slider 27, the rubbing roller 61 comes into contact with the recording paper S, and moves while rotating and rubbing along the surface of the recording paper S. Although the rubbing roller 61 is used in the second exemplary embodiment, the rubbing blade 26 of the first exemplary embodiment may be used.

### (Action of Second Exemplary Embodiment)

In the rubbing unit U4a′ of the second exemplary embodiment having the above-described configuration, the recording paper S is supported by the charged support belt 51. Then, in a state where the support belt 51 is stopped and the recording paper S is fixed, the recording paper S is rubbed by the rubbing roller 61. Therefore, also in the rubbing unit U4a′ of the second exemplary embodiment, the occurrence of paper wrinkles is suppressed, similarly to the first exemplary embodiment.

In the second exemplary embodiment, the support belt 51 is charged by the charging corotron 56 so that the recording paper S is fixed by electrostatic force. However, the present disclosure is not limited thereto. For example, the recording paper S may be charged instead of the support belt 51, or both the support belt 51 and the recording paper S may be charged. It is also possible to adopt the support base 21 and the rubbing transport roller 32, similarly to the first exemplary embodiment, and charge the support base 21 or the recording paper S without using the support belt 51 having the function of a carry-out means. Further, the charging means is not limited to a corotron, and any conventionally known charging mechanism such as a charging roller, a charging blade, or a charging brush can be employed.

In the second exemplary embodiment, the rotating rubbing roller 61 is used as a rubbing means. In case where the rubbing blade 26 is used, scratches may occur on the recording paper S. However, with the rubbing roller 61, the occurrence of scratches is suppressed.

### Third Exemplary Embodiment

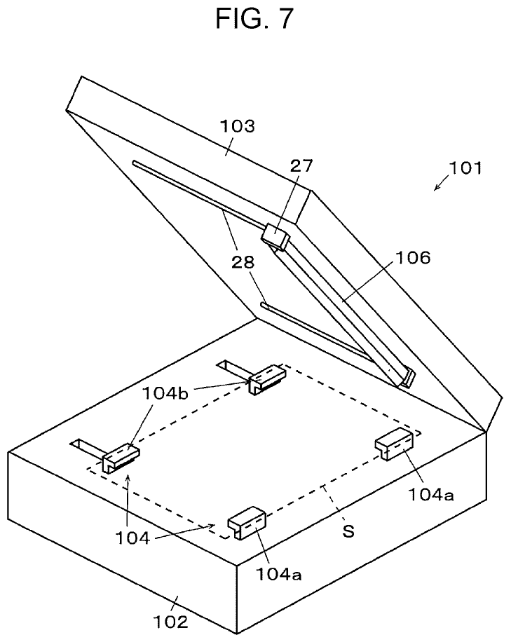

FIG. 7 is a perspective view of a rubbing device of a third exemplary embodiment.

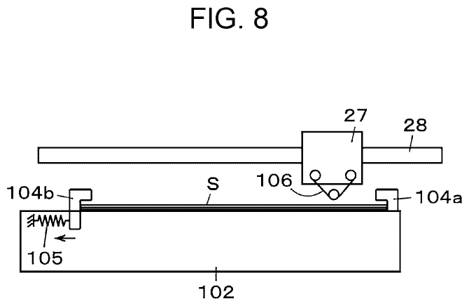

FIG. 8 is an explanatory view of the rubbing device of the third exemplary embodiment.

Next, the third exemplary embodiment of the present disclosure will be described. In the description of the third exemplary embodiment, components corresponding to those of the first exemplary embodiment are denoted by the same reference numerals, and detailed description thereof will be omitted.

The third exemplary embodiment is different from the first exemplary embodiment in the following points, but is similar to the first exemplary embodiment in the other points.

In FIGS. 7 and 8, a rubbing device 101 of the third exemplary embodiment is not configured to be connected to the printer U as in the first and second exemplary embodiments, but is configured as a device independent of the printer U.

The rubbing device 101 includes a support base 102 as an example of a support means. The rubbing device 101 also includes a cover 103 that can be opened and closed with respect to the support base 102, as an example of an opening and closing means.

The support base 102 includes holding hooks 104 as an example of a holding means. The holding hooks 104 of the third exemplary embodiment includes fixing hooks 104a as an example of a fixing holding means, and pulling hooks 104b as an example of a pulling holding means. The fixing hook 104a is fixed to and supported by the support base 102. The fixing hook 104a catches and holds one end side of the recording paper S from the thickness direction.

The pulling hook 104b is kept to be movable with respect to the support base 102. The pulling hook 104b of the third exemplary embodiment is supported to be movable in a direction approaching or separating from the fixing hook 104a. A coil spring 105 as an example of a pulling means is connected to the pulling hook 104b.

The coil spring 105 exerts elastic force that moves the pulling hook 104b in a direction separated from the fixing hook 104a.

Therefore, the pulling hook 104b catches and holds the other end side of the recording paper S from the thickness direction, and pulls the recording paper S in a direction where tensile force is applied to the recording paper S by the elastic force of the coil spring 105.

The rubbing guide rail 28 and the rubbing slider 27 are supported by the cover 103. A rubbing web 106 as an example of a rubbing means is supported by the rubbing slider 27. The rubbing web 106 is formed of a cloth-like rubbing member such as a nonwoven fabric, allowing the nonwoven fabric or the like to rub the surface of the recording paper S. The rubbing web 106 is wound every time the recording paper S is rubbed a predetermined number of times, and the used dirty surface is replaced with an unused surface.

In the third exemplary embodiment, the rubbing web 106 is used. However, the present disclosure is not limited thereto. It is possible to adopt the rubbing blade 26 or the rubbing roller 61 of the first and second exemplary embodiments. It is also possible to use the rubbing web 106 of the third exemplary embodiment in the configurations of the first and second exemplary embodiments.

### (Action of Third Exemplary Embodiment)

In the rubbing device 101 of the third exemplary embodiment having the above-described configuration, in a case where the rubbing processing is performed on the recording paper S on which an image is fixed, the recording paper S is manually set in the rubbing device 101 after being discharged from the printer U. That is, the cover 103 of the rubbing device 101 is opened, and the recording paper S is manually placed on the support base 102. Here, one end of the recording paper S is caught and fixed by the fixing hooks 104a, and the other end is caught by the pulling hooks 104b. When the recording paper S is fixed on the support base 102, the tensile force acts on the recording paper S by the elastic force of the coil spring 105. Therefore, the recording paper S is in a tensioned state.

Next, when the cover 103 is closed and a rubbing processing start button (not illustrated) is pressed, the rubbing web 106 is moved while being in contact with the surface of the recording paper S. In this manner, the upper surface of the recording paper S is rubbed, so that the wax is smoothed. Therefore, also in the rubbing device 101 of the third exemplary embodiment, image defects such as gloss unevenness are eliminated in a state where the occurrence of paper wrinkles is suppressed, similarly to the first and second exemplary embodiments.

In particular, in the third exemplary embodiment, the recording paper S is rubbed in a tensioned state. When the rubbing is performed in a state where the tensile force is not applied, wrinkles may occur in the recording paper S. However, this is suppressed in the third exemplary embodiment.

### (Modification)

Although the exemplary embodiments of the present disclosure have been described above in detail, the present disclosure is not limited to the above-described exemplary embodiments, and various modifications can be made within the scope of the gist of the present disclosure described in the claims. Modifications (H01) to (H03) of the present disclosure will be exemplified below.

(H01) In the above-described exemplary embodiment, the printer U is described as an example of the image forming apparatus. However, the image forming apparatus is not limited thereto, and may be, for example, a copying machine, a facsimile machine, or a multifunction peripheral having a plurality of or all of these functions. Further, the present disclosure is not limited to an electrophotographic image forming apparatus, and can be applied to any image forming apparatus such as an inkjet image forming apparatus or a thermal transfer image forming apparatus.

(H02) In the above-described exemplary embodiment, the configuration in which the developer of five colors are used is exemplified as the printer U. However, the present disclosure is not limited thereto, and can be also applied to a monochromatic image forming apparatus or a multi-color image forming apparatus of four colors or less or six colors or more. (H03) In the above-described exemplary embodiment, the aspect in which the finisher U5 is provided is exemplified. However, the present disclosure is not limited thereto. The present disclosure can be also applied to an image forming apparatus that does not include the finisher U5.

### APPENDIX

(((1)))

A post-processing apparatus comprising:
a support unit that fixes and supports a medium on which an image of a developer containing wax is fixed; and
a rubbing unit that rubs a surface of the medium supported by the support unit while being in contact with the surface of the medium and moving along the surface of the medium.
   (((2)))

The post-processing apparatus according to (((1))), further comprising: a suction unit that sucks air, wherein
the support unit fixes and supports the medium by suction force of the air.
   (((3)))

The post-processing apparatus according to (((2))), further comprising: a carry-out unit that rotates to carry out the supported medium, wherein
the support unit carries out the medium after the surface of the medium is rubbed.
   (((4)))

The post-processing apparatus according to (((1))), further comprising: a charging unit that charges at least one of a medium and the support unit, wherein
the support unit fixes and supports the medium by electrostatic force during charging.
   (((5))

The post-processing apparatus according to (((1))), further comprising: a holding unit that holds an end portion of the medium, wherein
the support unit fixes and supports the medium with the holding unit while tensile force is applied to the medium.
   (((6)))

The post-processing apparatus according to any one of (((1))) to ((5))), wherein the rubbing unit includes a rotating member that is in contact with the surface of the medium and moves while rotating along the surface of the medium.

(((7)))

The post-processing apparatus according to any one of (((1))) to (((5))), wherein the rubbing unit includes a plate-shaped member that moves along the surface of the medium while being in contact with the surface of the medium.

(((8)))

The post-processing apparatus according to any one of (((1))) to (wherein the rubbing unit includes a cloth-like rubbing member that moves while being in contact with the surface of the medium.

(((9)))

An image forming apparatus comprising:
an image forming unit that forms an image on an image holding member with a developer containing wax;
a transfer unit that transfers the image on the image holding member onto a medium;
a fixing unit that fixes the image transferred onto the medium; and
the post-processing apparatus according to any one of (((1))) to (((8))), including the rubbing unit that rubs the surface of the medium onto which the image has been fixed by the fixing unit.
   (((10)))

The image forming apparatus according to (((9))), comprising:
a carry-in unit that carries in the medium sent from the fixing unit to the support unit; and
a carry-out unit that carries out the medium after the surface is rubbed from the support member.

What is claimed is:

1. A post-processing apparatus comprising:
a support unit that fixes and supports a medium on which an image of a developer containing wax is fixed; and
a rubbing unit that rubs a surface of the medium supported by the support unit while being in contact with the surface of the medium and moving along the surface of the medium.

2. The post-processing apparatus according to claim 1, further comprising a suction unit that sucks air, wherein
the support unit fixes and supports the medium by suction force of the air.

3. The post-processing apparatus according to claim 2, further comprising a carry-out unit that rotates to carry out the supported medium, wherein
the support unit carries out the medium after the surface of the medium is rubbed.

4. The post-processing apparatus according to claim 1, further comprising a charging unit that charges at least one of a medium and the support unit, wherein
the support unit fixes and supports the medium by electrostatic force during charging.

5. The post-processing apparatus according to claim 1, further comprising a holding unit that holds an end portion of the medium, wherein
the support unit fixes and supports the medium with the holding unit while tensile force is applied to the medium.

6. The post-processing apparatus according to claim 1, wherein the rubbing unit includes a rotating member that is in contact with the surface of the medium and moves while rotating along the surface of the medium.

7. The post-processing apparatus according to claim 1, wherein the rubbing unit includes a plate-shaped member that moves along the surface of the medium while being in contact with the surface of the medium.

8. The post-processing apparatus according to claim 1, wherein the rubbing unit includes a cloth-like rubbing member that moves while being in contact with the surface of the medium.

9. An image forming apparatus comprising:
an image forming unit that forms an image on an image holding member with a developer containing wax;
a transfer unit that transfers the image on the image holding member onto a medium;
a fixing unit that fixes the image transferred onto the medium; and
the post-processing apparatus according to claim 1, including the rubbing unit that rubs the surface of the medium onto which the image has been fixed by the fixing unit.

10. An image forming apparatus comprising:
an image forming unit that forms an image on an image holding member with a developer containing wax;
a transfer unit that transfers the image on the image holding member onto a medium;
a fixing unit that fixes the image transferred onto the medium; and
the post-processing apparatus according to claim 2, including the rubbing unit that rubs the surface of the medium onto which the image has been fixed by the fixing unit.

11. An image forming apparatus comprising:
an image forming unit that forms an image on an image holding member with a developer containing wax;
a transfer unit that transfers the image on the image holding member onto a medium;
a fixing unit that fixes the image transferred onto the medium; and
the post-processing apparatus according to claim 3, including the rubbing unit that rubs the surface of the medium onto which the image has been fixed by the fixing unit.

12. An image forming apparatus comprising:
an image forming unit that forms an image on an image holding member with a developer containing wax;
a transfer unit that transfers the image on the image holding member onto a medium;
a fixing unit that fixes the image transferred onto the medium; and
the post-processing apparatus according to claim 4, including the rubbing unit that rubs the surface of the medium onto which the image has been fixed by the fixing unit.

13. An image forming apparatus comprising:
an image forming unit that forms an image on an image holding member with a developer containing wax;
a transfer unit that transfers the image on the image holding member onto a medium;
a fixing unit that fixes the image transferred onto the medium; and
the post-processing apparatus according to claim 5, including the rubbing unit that rubs the surface of the medium onto which the image has been fixed by the fixing unit.

14. An image forming apparatus comprising:
an image forming unit that forms an image on an image holding member with a developer containing wax;
a transfer unit that transfers the image on the image holding member onto a medium;
a fixing unit that fixes the image transferred onto the medium; and
the post-processing apparatus according to claim 6, including the rubbing unit that rubs the surface of the medium onto which the image has been fixed by the fixing unit.

15. An image forming apparatus comprising:
an image forming unit that forms an image on an image holding member with a developer containing wax;
a transfer unit that transfers the image on the image holding member onto a medium;
a fixing unit that fixes the image transferred onto the medium; and
the post-processing apparatus according to claim 7, including the rubbing unit that rubs the surface of the medium onto which the image has been fixed by the fixing unit.

16. An image forming apparatus comprising:
an image forming unit that forms an image on an image holding member with a developer containing wax;
a transfer unit that transfers the image on the image holding member onto a medium;
a fixing unit that fixes the image transferred onto the medium; and
the post-processing apparatus according to claim 8, including the rubbing unit that rubs the surface of the medium onto which the image has been fixed by the fixing unit.

17. The image forming apparatus according to claim 9, comprising:
a carry-in unit that carries in the medium sent from the fixing unit to the support unit; and
a carry-out unit that carries out the medium after the surface is rubbed from the support member.
